(19) United States
(12) Patent Application Publication
(10) Pub. No.: US 2008/0011819 A1
(43) Pub. Date: Jan. 17, 2008

(54) Verification of hit testing

(75) Inventors: Rahul V. Patil, Sammamish, WA (US); Robert A. Wlodarczyk, Redmond, WA (US); Vinay Kumar Venkatachalapathy, Seattle, WA (US)

Correspondence Address: MICROSOFT CORPORATION, ONE MICROSOFT WAY, REDMOND, WA, 98052-6399, US

(73) Assignee: Microsoft Corporation Microsoft Patent Group, Redmond, WA (US)

(21) Appl. No.: 11/484,480

(22) Filed: Jul. 11, 2006

(51) Int. Cl. G06F 17/00

(52) U.S. Cl. 235/375

(57) ABSTRACT

Various embodiments are disclosed relating to verification of hit testing. According to an example embodiment, a method may be provided. The example method may include associating each of a plurality of locations of an application display area with one of a plurality of visual elements, selecting one of the plurality of locations on the application display area, performing hit testing for the selected location to obtain an element ID for one of the plurality of visual elements for the selected location, and verifying that the element ID from the hit testing of the selected location matches the visual element associated with the selected location.

### BACKGROUND

Hit test programs are available to perform hit testing. An application display area may typically include one or more visual elements, such as selectable or clickable buttons, windows, text boxes, background, etc., or other visual elements. An application may, for example, register a routine with the hit test program for one or more visual elements. The registered routine may be called by the hit test program as an event handler if the hit test program determines that the corresponding visual element was selected or hit. Unfortunately, hit test programs do not always correctly test or determine the visual element that was selected or hit. Therefore, it may be useful to verify operation of the hit test program. However such hit test verification has typically been a manual process.

### SUMMARY

Various embodiments are disclosed relating to verification of hit testing. According to an example embodiment, a method may be provided. The example method may include associating each of a plurality of locations (or pixels) of an application display area with one of a plurality of visual elements, selecting one of the plurality of locations on the application display area, performing hit testing for the selected location to obtain an element ID for one of the plurality of visual elements for the selected location, and verifying that the element ID from the hit testing of the selected location matches or corresponds to the visual element associated with the selected location.

According to another example embodiment, a method is provided. The method may include determining one or more color codes for each of a plurality of visual elements applying an effect to a selected visual element of the plurality of visual elements of an application display area, and performing the following after the applying: associating each of the plurality of pixels of the application display area with one of the plurality of visual elements, selecting one of the plurality of pixels on the application display area, performing hit testing for the selected pixel to obtain an element ID for one of the plurality of visual elements for the selected location, and verifying that the element ID from the hit testing of the selected pixel matches the visual element associated with the selected pixel.

According to yet another example embodiment, a method is provided. The method may include associating each of a plurality of pixels of an application display area with one of a plurality of visual elements, selecting one of the plurality of pixels on the application display area, applying an effect to a selected visual element of the plurality of visual elements of the application display area, and performing the following after the applying: performing hit testing for the selected pixel to obtain an element ID for one of the plurality of visual elements for the selected location, and verifying that the element ID from the hit testing of the selected pixel matches the visual element associated with the selected pixel.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a computing system according to an example embodiment.

FIG. 2 is a block diagram of a software stack to according to an example embodiment to perform hit test verification.

FIG. 3 is an example of an application display area that may be generated by a program for hit testing and verification according to an example embodiment.

FIG. 4 is a diagram illustrating application of an effect to a visual element where a hit test bounds for the visual element may change when the effect is applied, according to an example embodiment.

FIG. 5 is a diagram illustrating application of an effect to a visual element where a hit test bounds and a visual bounds for the visual element may change in a same manner and are the same after the effect.

FIG. 6 is a diagram illustrating application of an effect to a visual element where both a hit test bounds and a visual bounds for the visual element by the effect.

FIG. 7 is a flow chart illustrating operation of hit test verification according to an example embodiment.

FIG. 8 is a flow chart illustrating operation of hit test verification according to another example embodiment.

FIG. 9 is a flow chart illustrating operation of hit test verification according to yet another example embodiment.

### DETAILED DESCRIPTION

Referring to the Figures in which like numerals indicate like elements,

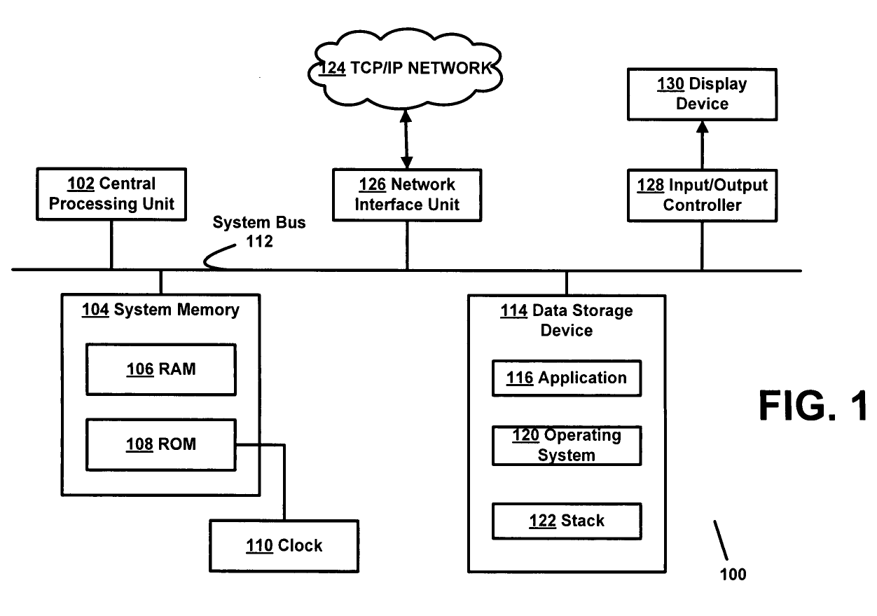

FIG. 1 is a block diagram of a computing system 100 according to an example embodiment. Various embodiments may be practiced or implemented within computing system 100 or other computing system, according to an example embodiment. Computing system 100 may include, for example, a laptop computer, a desktop computer, a personal computer (PC), a server, a network device (e.g., switch, router), cellular telephone, personal digital assistant (PDA), gaming device, handheld communications device, or other computing device. These are merely a few examples, and the various embodiments are not limited thereto.

The system 100 may include a central processing unit (“CPU”) 102, a system memory 104 including a random access memory 106 (“RAM”) and a read-only memory 108 (“ROM”). The CPU 102 may interpret instructions and process data in computer applications. For example, the CPU 102 may be a microprocessor and include a number of integrated circuits, and may execute software or instructions and provide overall control to computing system 100. The RAM 106 may allow data stored on the RAM to be accessed in any order, the system 100 may also for example write to and read from the RAM 106. For example, a data file may be stored on the RAM 106 at a time X, and at a time Y the data file may be read from the RAM 106. The ROM 108 may contain data or systems that may be read from the ROM 108 by the system 100 (as opposed to the RAM 106 which generally may be written to or read by the system 100). For example the ROM 108 may comprise a basic input/output system (BIOS) software code to be run by the system 100 when the system 100 is first powered on. The ROM 108 may also for example be coupled to a clock 110. The clock 110, for example, may provide the time to the system 100 through the ROM 108.

The system 100 may also include an input/output controller 128 and a display device 130. Input/output (I/O) controller 128 may interface to one or more I/O devices, such as display device 130. The input/output controller 128 may, for example, provide output to the display device 130. The display device 130 may be a device configured to receive data from the input/output controller 128 and provide or display the data to a user. Although not shown, the input/output controller 128 may also be coupled to a variety of input devices, such as a keyboard, mouse, joystick, or any other input device configured to provide input to the system 100.

The system 100 may also include a data storage device 114 to store data, instructions or other information. Data storage device 114 may be, for example, a hard disk drive that stores data on a magnetic surface, a CD-ROM, or any other available media storage device accessible by the system 100.

By way of example, and not limitation, data storage device 114 may include any computer-readable media. The computer readable media may, for example, include computer storage media and communication media. Computer storage media may include media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

One or more software programs or blocks may be stored in data storage device 114, such as an application 116, an operating system 120, and a stack 122. Application 116 may be a web browser, word processor, a multimedia application, or any other application. The operating system 120 may be a software program that manages the hardware and software of the system 100, and may be any type of operating system. For example, the operating system may be Microsoft Windows, Linux, etc. The stack 122 may be a temporary data structure used to store data from the data storage device 114.

According to an example embodiment the system 100 may operate in a networked environment using logical connections to communicate with remote computers through a network, such as a TCP/IP network 124, as an example. For example, the TCP/IP network 124 may be the Internet, a corporate intranet, a local area network, a wireless network, a wide area network, and/or any other network. The system 100 may communicate to the TCP/IP network 124 through a network interface unit 126. The network interface unit 126 may be a device and/or software program configured to allow the system 100 to communicate with the TCP/IP network 124. For example, the network interface unit 126 may be a network card, network interface controller (NIC), a modem, or any other communication enabling device.

A system bus 112 may be coupled to the CPU 102, the system memory 104, data storage device 114, network interface unit 126, and input/output controller 128. The system bus 112 may allow transfer of data between two or more system components. For example the system bus 112 may allow for transfer of data to and from the system memory 104 and CPU 102. The system bus 112 may also, for example, couple other parts of the system 100 together as well, such as the data storage device 114 to the input/output controller 128.

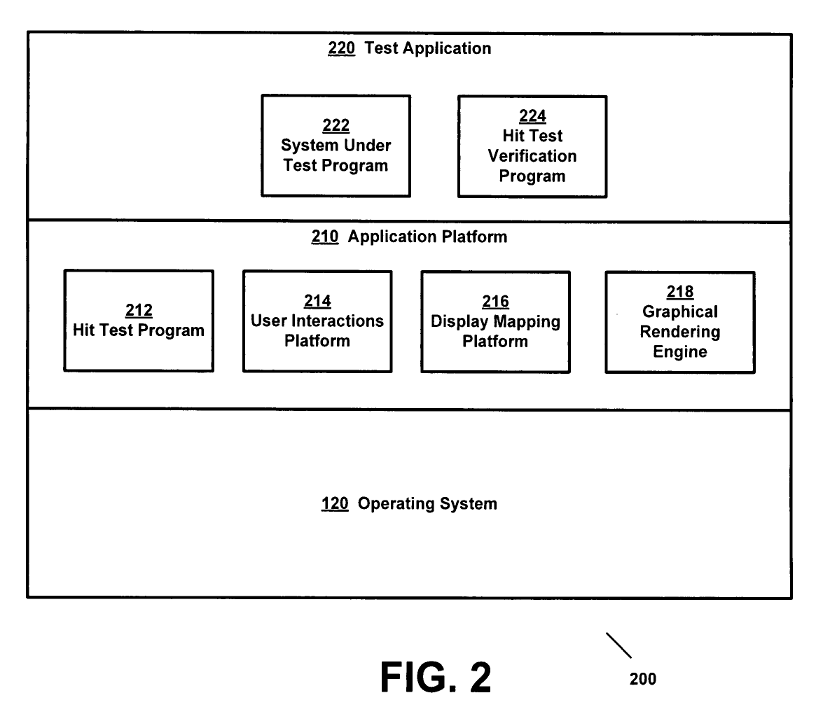

FIG. 2 is a block diagram of a software stack 200 to according to an example embodiment to perform hit test verification. In an example embodiment, application 116 (FIG. 1) may generally be implemented to include an application platform 210 and a test application 220. Application platform 210 may include, for example, a hit test program 212, a user interactions platform 214, a display mapping platform 216, and a graphical rendering engine 218. Test application 220 may include, for example, a system under test program 222 and a hit test verification program 224.

Hit test program 212 may perform hit testing. An application display area may typically include one or more visual elements, such as selectable or clickable buttons, windows, text boxes, background, etc., or other visual elements. In an example embodiment, an application may, for example, register a routine with the hit test program 212 for one or more visual elements. In an example embodiment, hit test program 212 may call or invoke the registered routines as event handlers when, for example, a visual element is hit or selected, e.g., by a mouse or other pointing device. In an example embodiment, when a specific location or pixel in a application display area is selected, hit test program 212 may perform hit testing in attempt to determine which visual element has been selected.

In an example embodiment, the hit test program 212 may provide an element ID identifying the visual element that the hit test program 212 has determined was selected (or clocked) or hit by the mouse or pointing device. However, it is possible that the hit test program 212 may incorrectly determine the visual element that was selected. For example, in some cases, the selectability rules, e.g., for determining when a visual element has been selected may have changed. For example, if a visual element is modified or transformed, the visual bounds and/or the hit test bounds for the visual element may have been modified in some manner, and may or may not match each other, which may complicate the task performed by the hit test program in some cases. Therefore, it may be useful, at least in some cases, to verify that the hit test program 212 is correctly identifying the selected visual elements. Until now, the verification of hit testing has been a manual operation.

According to an example embodiment, a hit test verification program 224 may verify the operation of the hit test program 212. A system under test (SUT) program 222 may provide a sample application that may be used for testing and verification, for example.

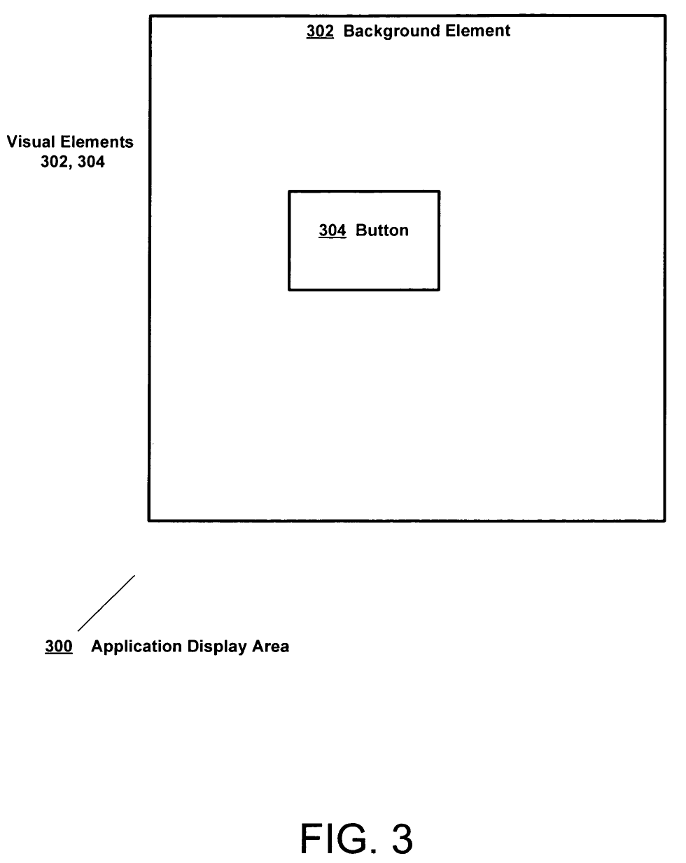

FIG. 3 is an example of an application display area 300 that may be generated by SUT program 222 for hit testing and verification according to an example embodiment. Application display area 300 may include a plurality of visual elements, such as a background element 302 and a button 304. While only two visual elements are provided in this example, any number of visual elements may be used. In an example embodiment, one or more color codes may be determined for each of the plurality of visual elements. For example, background element 302 may be white, while button 304 may be black, although this is a simple example. Other examples involving more elements and/or more color codes may be used.

In addition, each location or pixel of application display area may also have a color or color code. Therefore, at any particular time, each pixel on application display area 300 may be associated with one of the plurality of visual elements based on a match between the color code for the pixel and the color code determined for a visual element. For example, a pixel on display area 300 that is black may be associated with (or correspond to) button 304 (since button 304 is black), while a white pixel may be associated with background 302 (since background 302 is also white), as examples. In an example embodiment, this information (e.g., association between pixel color codes and visual element color codes) may be used by hit test verification program 224 to verify operation of hit test program 212, for example.

Referring to FIG. 2 again, user interactions platform 214 may provide or simulate a mouse or pointer movement. Thus, in an example embodiment, SUT program 222 or hit test verification program 224 may call or invoke user interactions platform 214 to move a mouse or pointer to a new [x,y] location or pixel on display area 300 and then to select or click on that location or pixel, for example. In response to the mouse movement and selection of a location or pixel by user interactions platform 214, hit test program 212 may attempt to determine the visual element that was selected. Hit test program 212 may output an element ID identifying a selected visual element as determined by the hit test program 212. Hit test verification program 224 may then compare the element ID for the selected location or pixel from the hit test program 212 to the visual element previously associated with the selected pixel. If the element ID from the hit test program 212 for the selected pixel matches the visual element associated with the selected pixel, then this confirms or verifies that the hit test program has correctly determined the selected visual element.

This process may be repeated. That is, user interactions platform 214 may move the mouse or pointer to select a new pixel on display 300. Hit test program 212 may then provide an element ID for the selected pixel that identifies the visual element hit test program 212 has determined was selected or hit. Hit test verification program 224 may then verify the operation of the hit test program 212 for the new selected pixel, e.g., by verifying that the element ID from the hit testing of the selected pixel matches the visual element associated with the selected pixel.

Referring to FIG. 2, display mapping platform 216 may perform mapping of display or input information to a selected visual element, e.g., maps input text to a selected text box. Graphical rendering engine 218 may perform graphical rendering, e.g., for the application display area 300 to be displayed or output onto a monitor, display or other output device, for example.

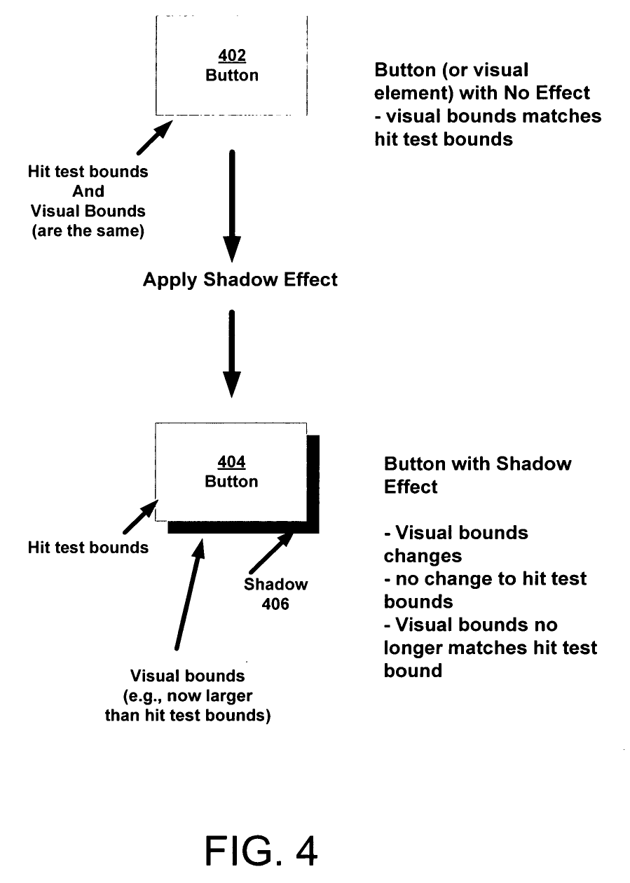

FIG. 4 is a diagram illustrating application of an effect to a visual element where a hit test bounds for the visual element may change when the effect is applied, according to an example embodiment. A visual element, such as a button 402 which may be selected or clicked, is shown with no effect. For button 402, a visual bounds (e.g., bounds of visual element as shown) and a hit test bounds (e.g., bounds of area that may be selected to select the visual element) are the same in this example. A shadow or drop shadow effect is then applied to button 402 to produce button 404. Shadow effect is merely an example effect or modifier, as other types of effects that may change visual bounds but not hit test bounds may include transforms such as a blurring effect.

After the effect is applied, button 404 now includes the area that was previously button 402, plus a shadow 406. After the shadow effect is applied to the button, the hit test bounds for button 404 does not change (is same as hit test bounds for button 402), but the visual bounds for button 404 is now larger than for button 402 due to the shadow 406. Therefore, the visual bounds no longer matches the hit test bounds for button 404. When this effect is applied to a button or other visual element, the selectabilty rules may therefore, change. Thus, if a user or mouse selects a location or pixel in the shadow 406, this is not a selection or hit on button 404. Hit test verification program 224 may, for example, verify that hit test program 212 is correctly determining when button 404 is selected or not (e.g., properly determining that a selection of a pixel within shadow 406 is a selection of a background or other element, and not a selection of button 404).

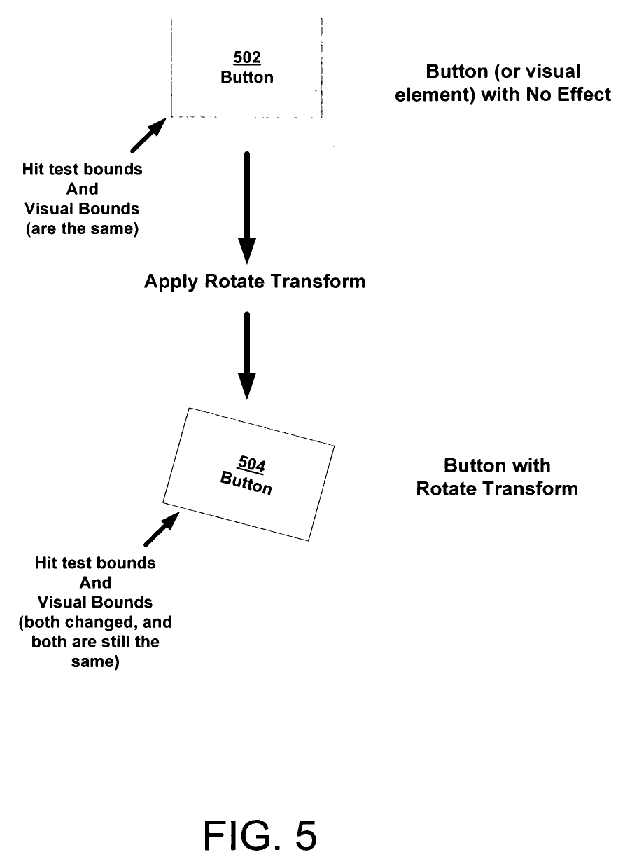

FIG. 5 is a diagram illustrating application of an effect to a visual element where a hit test bounds and a visual bounds for the visual element may change in a same manner and are the same after the effect. A number of different effects may be applied where both visual bounds and hit test bounds may change together or change in a same manner, such as rotation, skew, expand, explode, swirl, etc.

In FIG. 5, a button 502 is shown prior to application of an effect. A rotate effect is then applied to the button 502 to produce button 504, which is now rotated. Both the visual bounds and the hit test bounds are rotated for button 504. In FIG. 5, the visual bounds and the hit test bounds of the button are the same both before (502) and after (504) the rotation of the button, according to an example embodiment.

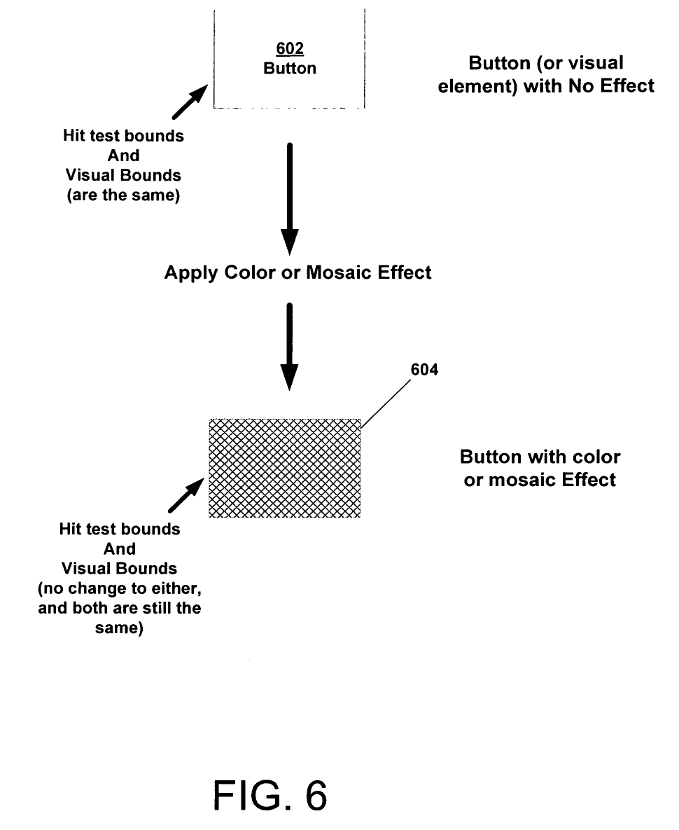

FIG. 6 is a diagram illustrating application of an effect to a visual element where both a hit test bounds and a visual bounds for the visual element by the effect. A number of different effects may be applied that would not change the hit test bounds or visual bounds, such as mosaic, color, bevel, for example. In button 602, the visual bounds and the hit test bounds are the same prior to applying the mosaic or color effect. After the mosaic or color effect, both the visual bounds and the hit test bounds are unchanged and are still the same (still match).

The effects illustrated in FIG. 4-6 illustrate some example effects that may be applied to visual elements. These are merely example effects, and many other effects may be used. As noted, by applying one or more effects to a visual element, this may or may not change the selectability rules, and/or may make it more difficult for a hit test program 212 to correctly determine when different visual elements are selected. In an example embodiment, a same general approach or technique may be used for hit test verification, regardless whether hit test bounds and visual bounds match after applying an effect to a visual element. In other example embodiments, slightly different techniques may be used to perform hit test verification depending on, for example, whether or not the visual bounds matches the hit test bounds for the visual element after applying the effect to the visual element.

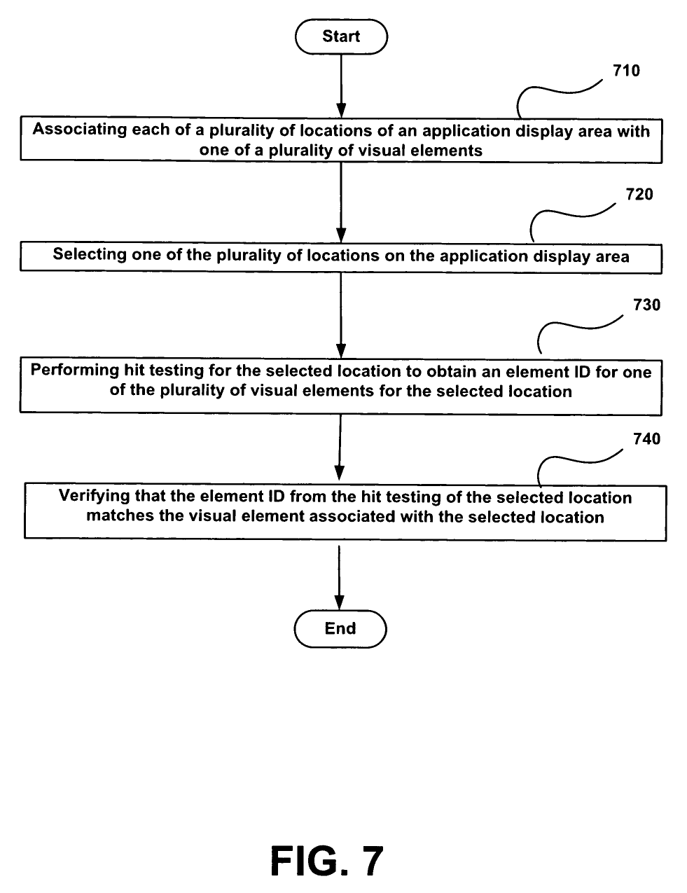

FIG. 7 is a flow chart illustrating operation of hit test verification according to an example embodiment.

At 710, each of a plurality of locations (or pixels) of an application display area may be associated with one of a plurality of visual elements. This associating (operation 710) may include, for example, one or more of determining one or more color codes for each of a plurality of visual elements (e.g., white for background, black for a button), determining a color code for each of a plurality of pixels, and/or associating each of the plurality of pixels of the application display area with one of the visual elements based on a match between a color code of a pixel and a color code of a visual element.

At 720, one of a plurality of locations (or pixels) on the application display area may be selected. For example, hit test verification program 224 may call user interactions platform 214 to move a mouse or pointer and click or select a location or pixel, for example.

At 730, hit testing may be performed for the selected location or pixel to obtain an element ID for one of the plurality of visual elements for the selected location or pixel. Hit testing (730) may be performed, for example, by registering with hit test program 212 for one or more visual elements, and/or receiving an element ID or notification when the hit test program determines that a visual element has been selected or hit, for example. In another example embodiment, hit testing may be performed by making a call to hit test program 212 to perform hit testing on the selected location and to obtain an element ID for one of the plurality of visual elements for the selected location.

At 740, the operation of the hit testing may be verified. For example, it may be verified that the element ID from the hit testing of the selected location (e.g., received from hit test program 212) matches the visual element associated with the selected location or pixel. Thus, it may be verified, e.g., through a comparison, that the element ID received via operation 730 matches or corresponds to the visual element associated with the selected pixel (from operation 710). This may confirm, for example, that the hit test program has correctly operated (correctly tested), at least for this test.

The hit test verification, or any operations thereof, described and shown in FIG. 7 (or other FIGs.), may be performed for a pixel or location that is selected on a visual element that may be with or without an effect, for example. One or more of the visual elements may be selected or not selected. The operation of FIG. 7 may be repeated for one or more pixels or locations, or for even all pixels or locations in a display area, for example.

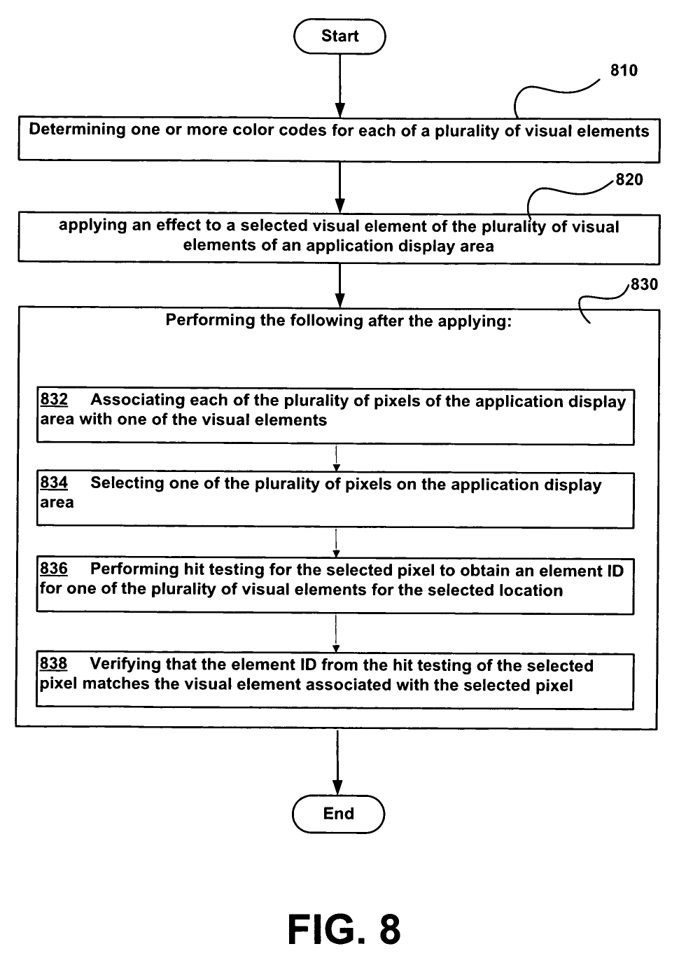

FIG. 8 is a flow chart illustrating operation of hit test verification according to another example embodiment.

At 810, one or more color codes may be determined for each of a plurality of visual elements. For example, a white color code may be used for background 302, and black may be used for button 304, etc.

At 820, an effect may be applied to a selected visual element of the plurality of visual elements of an application display area. The effect may be any effect, such as one of the effects shown in FIGS. 4-6, for example. In an example embodiment, the applying an effect (820) may include applying an effect to a selected visual element of the plurality of visual elements of an application display area, wherein a visual bounds for the selected visual element matches a hit test bounds for the selected visual element both before and after the applying the effect to the selected visual element (e.g., such as shown in the examples of FIGS. 5 and 6).

At 830, one or more additional operations may be performed after the applying (820) operation, including operations 832, 834, 836, and 838.

At operation 832, each of a plurality of pixels of an application display area (e.g., area 300) may be associated with one of the visual elements. The operations 832 may include, for example, determining a color code for each of a plurality of pixels of the application display area, and associating each of the plurality of pixels of the application display area with one of a plurality of visual elements.

For example, a screen shot may be taken of the display area 300, after the effect has been applied. The color codes for each pixel may be identified and an array of color codes may be determined, where each pixel color code may indicate or may be associated with a visual element. For example:
a. Colorcode[x,y]=white, indicating a pixel of background 302
b. Colorcode[x,y]=black, indicating a pixel of button 304 after the effect has been applied

At operation 834, one of a plurality of pixels of the application display area is selected. For example, hit test verification program 224 may call user interactions platform 214 to move a mouse or pointer and click or select a location or pixel on application display area 300, for example.

At operation 836, hit testing is performed for the selected pixel to obtain an element ID for one of the plurality of visual elements for the selected location. Hit testing (836) may be performed, for example, by registering with hit test program 212 for one or more visual elements, and/or receiving an element ID or notification when the hit test program determines that a visual element has been selected or hit, for example. In another example embodiment, hit testing may be performed by making a call to hit test program 212 to perform hit testing on the selected location.

For example, hit testing may include receiving a list of visual elements or element IDs for one or more, or even all, of the location or pixels of display area 300. For example:
a. Hit-Visual-Element[x,y]=white if background element 302 was hit
b. Hit-Visual-Element[x,y]=black if button 304 was hit

### Thus, a color code for an element may be used as an element ID or identifier for the visual element, but any type of element ID or identifier may be used.

At operation 838, it is verified that the element ID from hit testing of the selected pixel matches or corresponds to the visual element associated (e.g., associated in operation 832) with the selected pixel. For example, the color codes for a selected pixel (or all pixels) are compared to the color codes for visual elements to make sure there is a match.

For example, hit test verification may include verifying that, for a selected pixel, or for one or more (or even all) pixels of display area 300:
a. Verifying that if Hit-Visual-Element[x,y]=white, then Colorcode[x,y]=white (meaning background)
b. Verifying that if Hit-Visual-Element[x,y]=black, then Colorcode[x,y]=black (meaning button 304)

With reference to FIG. 8, in an example embodiment, at operation 832 each pixel may be associated with one of the visual elements after the effect has been applied to a visual element, where visual bounds and hit bounds still match after the effect is applied, for example. This is because, for example, the post-effect visual bounds may be used in such example to mark or indicate the hit bounds for the visual element, since these two bounds may typically match after the effect is applied (in this example). Thus, with this type of effect, color codes, after the application of the effect, may be used to associate pixels with visual elements, and then used to verify hit testing, for example.

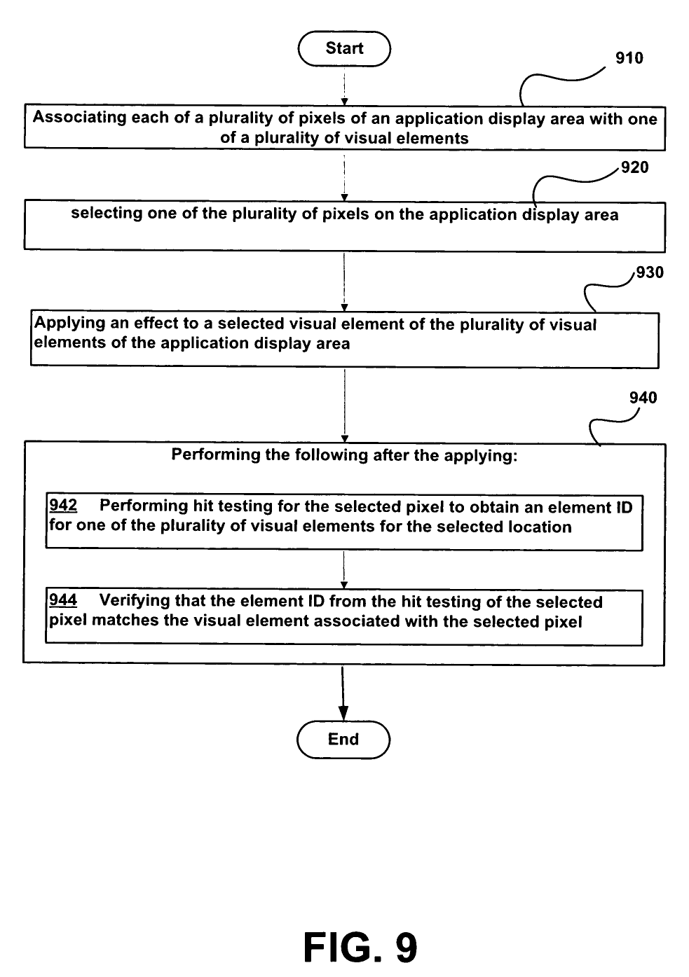

FIG. 9 is a flow chart illustrating operation of hit test verification according to yet another example embodiment.

At 910, each of a plurality of pixels of an application display area may be associated with one of a plurality of visual elements. Operation 910 may include, for example, determining one or more color codes for each of a plurality of visual elements, determining a color code for each of a plurality of pixels of the application display area, and associating each of the plurality of pixels of the application display area with one of the plurality of visual elements based on a match between a color code of the pixel and a determined color code for one of the visual elements.

At 920, one of the plurality of pixels on the application display area may be selected. Different techniques may be used to select a location or pixel, such as those technique noted above with reference to FIGS. 7 and 8, among others.

At 930, an effect may be applied to a selected visual element of the plurality of visual elements of the application display area. Any effect may be applied. However, in an example embodiment, the applying operation of 930 may include applying an effect to a selected visual element of the plurality of visual elements of an application display area, wherein a visual bounds for the selected visual element does not match a hit test bounds for the selected visual element after the applying the effect to the selected visual element.

At 940, one or more additional operations may be performed after the applying operation (930), including operations 942 and 944.

At 942, hit testing may be performed for the selected pixel to obtain an element ID for one of the plurality of visual elements for the selected location or pixel. At 944, it may be verified that the element ID from the hit testing of the selected pixel matches the visual element associated with the selected pixel. As with FIG. 8, the verifying operation (944) may be performed by verifying that, for a selected pixel, or for one or more (or even all) pixels of display area 300:
a. Verifying that if Hit-Visual-Element[x,y]=white, then Colorcode[x,y]=white (meaning background)
b. Verifying that if Hit-Visual-Element[x,y]=black, then Colorcode[x,y]=black (meaning button 304)

With reference to FIG. 9, at operation 910, each pixel may be associated with one of the visual elements before the effect has been applied to a visual element where visual bounds and hit bounds will not (or do not) match after the effect has been applied, for example. An example of this type of effect is illustrated in FIG. 4. This is because, for example, the post-effect visual bounds in such case may not be effectively used to mark or indicate the hit bounds for the visual element, since these two bounds may not typically match after the effect has been applied to the visual element (in this example). Thus, with this type of effect, color codes, obtained before the application of the effect, may be used, for example, to associate pixels with visual elements, and then used to verify hit testing after the effect has been applied, since the pre-effect visual bounds of the visual element may accurately mark the hit bounds even after the effect has been applied.

While certain features of the described implementations have been illustrated as described herein, many modifications, substitutions, changes and equivalents may now occur to those skilled in the art. It is, therefore, to be understood that the appended claims are intended to cover all such modifications and changes as fall within the true spirit of the various embodiments.

What is claimed is:

1. A method comprising:
associating each of a plurality of locations of an application display area with one of a plurality of visual elements;
selecting one of the plurality of locations on the application display area;
performing hit testing for the selected location to obtain an element ID for one of the plurality of visual elements for the selected location; and
verifying that the element ID from the hit testing of the selected location matches the visual element associated with the selected location.

2. The method of claim 1 wherein the associating comprises:
determining one or more color codes for each of a plurality of visual elements;
associating each of a plurality of pixels of an application display area with one of the plurality of visual elements based on the determined color codes for each of the visual elements.

3. The method of claim 1 wherein the selecting one of the plurality of locations on the application display area comprises selecting one of a plurality of pixels on the application display area.

4. The method of claim 1 wherein the performing hit testing comprises:
calling a hit test program to perform hit testing on the selected location and to obtain an element ID for one of the plurality of visual elements for the selected location.

5. The method of claim 1 wherein the verifying comprises:
comparing the element ID from the hit testing of the selected location to the visual element associated with the selected location.

6. The method of claim 1 wherein the associating comprises:
determining one or more color codes for each of a plurality of visual elements;
applying an effect to a selected visual element of the plurality of visual elements of an application display area;
determining a color code for each of a plurality of pixels of the application display area; and
associating each of the plurality of pixels of the application display area with one of the plurality of visual elements based on a match between a color code of the pixel and a determined color code for one of the visual elements.

7. The method of claim 6 wherein the applying comprises:
applying an effect to a selected visual element of the plurality of visual elements of an application display area, wherein a visual bounds of the selected visual element matches a hit test bounds for the selected visual element both before and after the applying the effect to the selected visual element.

8. The method of claim 1:
wherein the associating comprises:
determining one or more color codes for each of a plurality of visual elements;
determining a color code for each of a plurality of pixels of the application display area; and
associating each of the plurality of pixels of the application display area with one of the plurality of visual elements based on a match between a color code of the pixel and a determined color code for one of the visual elements;
wherein the selecting comprises selecting one of the plurality of pixels on the application display area;
wherein the performing hit testing comprises:
applying an effect to a selected visual element of the plurality of visual elements of the application display area; and
performing hit testing for the selected pixel to obtain an element ID for one of the plurality of visual elements for the selected pixel.

9. The method of claim 8 wherein the applying comprises:
applying an effect to a selected visual element of the plurality of visual elements of an application display area, wherein a visual bounds for the selected visual element does not match a hit test bounds for the selected visual element after the applying the effect to the selected visual element.

10. A method comprising:
determining one or more color codes for each of a plurality of visual elements;
applying an effect to a selected visual element of the plurality of visual elements of an application display area; and
performing the following after the applying:
associating each of the plurality of pixels of the application display area with one of the plurality of visual elements;
selecting one of the plurality of pixels on the application display area;
performing hit testing for the selected pixel to obtain an element ID for one of the plurality of visual elements for the selected location; and
verifying that the element ID from the hit testing of the selected pixel matches the visual element associated with the selected pixel.

11. The method of claim 10 wherein the associating comprises:
determining a color code for each of a plurality of pixels of the application display area; and
associating each of the plurality of pixels of an application display area with one of a plurality of visual elements.

12. The method of claim 10 wherein the applying comprises:
applying an effect to a selected visual element of the plurality of visual elements of an application display area, wherein a visual bounds for the selected visual element matches a hit test bounds for the selected visual element both before and after the applying the effect to the selected visual element.

13. A method comprising:
associating each of a plurality of pixels of an application display area with one of a plurality of visual elements;
selecting one of the plurality of pixels on the application display area;
applying an effect to a selected visual element of the plurality of visual elements of the application display area; and
performing the following after the applying:
performing hit testing for the selected pixel to obtain an element ID for one of the plurality of visual elements for the selected location; and
verifying that the element ID from the hit testing of the selected pixel matches the visual element associated with the selected pixel.

14. The method of claim 13 wherein the associating comprises:
determining one or more color codes for each of a plurality of visual elements;
determining a color code for each of a plurality of pixels of the application display area; and
associating each of the plurality of pixels of the application display area with one of the plurality of visual elements based on a match between a color code of the pixel and a determined color code for one of the visual elements.

15. The method of claim 13 wherein the applying comprises:
applying an effect to a selected visual element of the plurality of visual elements of an application display area, wherein a visual bounds for the selected visual element does not match a hit test bounds for the selected visual element after the applying the effect to the selected visual element.

16. The method of claim 13 wherein the applying comprises:
applying an effect to a selected visual element of the plurality of visual elements of an application display area, wherein a visual bounds for the selected visual element matches a hit test bounds for the selected visual element before the applying the effect to the selected visual element, and wherein a visual bounds for the selected visual element does not match a hit test bounds for the selected visual element after the applying the effect to the selected visual element.
